(19) United States
(12) Patent Application Publication
(10) Pub. No.: US 2026/0353417 A1
(43) Pub. Date: Nov. 5, 2026

(54) SIDELINK COMMUNICATION METHOD AND APPARATUS

(71) Applicant: Beijing Xiaomi Mobile Software Co., Ltd., Beijing (CN)

(72) Inventor: Qun ZHAO, Beijing (CN)

(21) Appl. No.: 19/102,781

(22) PCT Filed: Aug. 12, 2022
(86) PCT No.: PCT/CN2022/112317

§ 371 Date: Feb. 10, 2025

(51) Int. Cl. H04W 72/40

(52) U.S. Cl. CPC H04W 72/40

(57) ABSTRACT

A sidelink communication method, includes: acquiring first configuration information of a sidelink (SL) synchronization resource of a first radio access technology (RAT) and second configuration information of an SL synchronization resource of a second RAT on a first carrier; and determining a logical time unit of the second RAT according to the first configuration information and the second configuration information.

### CROSS-REFERENCE TO RELATED APPLICATIONS

The present application is a U.S. National Stage of International Application No. PCT/CN2022/112317, filed on PCT Aug. 12, 2022, the contents of all of which are incorporated herein by reference in their entireties for all purposes.

### BACKGROUND OF THE INVENTION

With the continuous evolution of communication technologies, more and more users have mobile devices or Internet of Things (IoT) devices. Mobile network communication technologies such as a sidelink (SL) provide technical support for the interconnection of things in many application scenarios. At the same time, the continuous emergence of a new generation of new Internet applications has put forward higher requirements for wireless communication technologies.

### SUMMARY OF THE INVENTION

The present disclosure relates to the technical field of mobile communications, in particular to a sidelink communication method and apparatus.

An embodiment of a first aspect of the present disclosure provides a sidelink communication method. The method is performed by the end UE. The method includes: acquiring first configuration information of a sidelink (SL) synchronization resource of a first radio access technology (RAT) and second configuration information of an SL synchronization resource of a second RAT on a first carrier; and determining a logical time unit of a second RAT according to the first configuration information and the second configuration information.

An embodiment of a second aspect of the present disclosure provides a communication apparatus, including a transceiver, a memory, and one or more processors which are connected to the transceiver and the memory and configured to control; where the one or more processors are collectively configured to execute the computer program stored in the memory, so as to cause the communication apparatus to perform the method as described according to the embodiments of the first aspect of the present disclosure.

An embodiment of a third aspect of the present disclosure provides a non-transitory computer-readable storage medium, storing computer-executable instructions, where the computer-executable instructions, after being executed by one or more processors, implement the method as described according to the embodiments of the first aspect of the present disclosure.

Additional aspects and advantages of the present disclosure will be partially given in the following description, and partially become apparent in the following description, or will be learned by practice of the present disclosure.

### BRIEF DESCRIPTION OF DRAWINGS

The above and/or additional aspects and advantages of the present disclosure will become apparent and readily appreciated from the following description of the embodiments, taken in conjunction with the accompanying drawings.

FIG. 1 is a schematic diagram of a mode for determining a logical time unit according to an embodiment of the present disclosure.

FIG. 2 is a schematic flowchart of a sidelink communication method according to an embodiment of the present disclosure.

FIG. 3 is a schematic flowchart of another sidelink communication method according to an embodiment of the present disclosure.

FIG. 4 is a schematic diagram of a method for determining a synchronization time unit according to an embodiment of the present disclosure.

FIG. 5 is a schematic diagram of a mode for determining a logical time unit according to an embodiment of the present disclosure.

FIG. 6 is a block diagram of a sidelink communication apparatus according to an embodiment of the present disclosure.

FIG. 7 is a block diagram of another sidelink communication apparatus according to an embodiment of the present disclosure.

FIG. 8 is a schematic structural diagram of a communication apparatus according to an embodiment of the present disclosure.

FIG. 9 is a schematic structural diagram of a chip according to an embodiment of the present disclosure.

### DETAILED DESCRIPTION OF THE INVENTION

Embodiments of the present disclosure will be described below in detail, examples of which are illustrated in the accompanying drawings. The same or similar reference numerals refer to the same or similar elements or elements having the same or similar functions throughout. The embodiments described below with reference to the accompanying drawings are illustrative, and are intended to be used to interpret the present disclosure and should not be construed as a limitation on the present disclosure.

With the rapid development of mobile communication technologies, the interconnection of things technology has become an inevitable trend in the development of future communication networks, and the more performance-friendly sidelink communication technology has emerged based on a 3rd Generation Partnership Project (3GPP) standard. With the continuous emergence of a new generation of new Internet applications (such as vehicle to everything (V2X)), higher requirements are put forward for a wireless communication technology, which drives the continuous evolution of the wireless communication technology to meet the needs of applications.

In order to better support Internet of Vehicles communication, in a transition process of a third generation mobile communication technology (3G) and a fourth generation mobile communication technology (4G), LTE V2X is formulated in long term evolution (LTE) release 14 (LTE Release 14) to support communication between Internet of Vehicles devices (such as vehicle-to-vehicle, vehicle-to-person, vehicle-to-roadside node) via a sidelink (SL). In the subsequent release 15 (Release15), the LTE V2X technology is enhanced to support carrier aggregation and other functions. In a fifth generation mobile communication technology (5G), after Release 15 of a 5G New Radio (NR) technology is formulated, the work of using an NR interface to support Internet of Vehicles communication is started by the 3GPP, and a 5G SL is completed in Release 16 to support sidelink communication between the Internet of Vehicles devices through the NR technology. Due to the difference of physical layer design of LTE and NR, there is no direct communication between LTE V2X devices and NR V2X devices.

In addition, due to the relatively long replacement time of vehicles, there is a need to consider the coexistence of Internet of Vehicles devices supporting LTE V2X and Internet of Vehicles devices supporting NR V2X. In Release 16, a case that LTE V2X and NR V2X operate on different carrier frequencies is considered. In the recent 3GPP Release 18 discussion, the coexistence of LTE V2X and NR V2X operating on the same carrier frequency is discussed, and it is proposed that the V2X technology supporting the two can dynamically share time-frequency resources on the same carrier frequency. As LTE V2X is a starting system, improvements to NR V2X should be prioritized to support to share spectrum resources.

In the related art, in order to support the transmission and reception of SL synchronizing signals, both NR and LTE need to be configured with SL synchronization time-frequency resources. SL resource pools used in SL communications of NR and LTE are defined on respective logical time units. LTE is a logic subframe and NR is a logic slot. Thus, a logical time unit needs to be determined.

However, in one application scenario, when user equipment (UE) supports two types of RATs, for example, when the UE supports both the LTE SL technology and the NR SL technology, and during sidelink communication between UE, for example, communication with other UE that supports the LTE SL technology is performed through an LTE communication technology, or communication with other UE that supports the NR SL technology is performed through an NR communication technology, if each RAT removes a time unit of own SL synchronizing signals or broadcast channels, determined logical time units of the two types of RATs will be different. For example, a synchronization time unit of an LTE SL may belong to a logical time unit of an NR SL, and vice versa. Since the SL resource pools are defined on logical time units, it may cause an LTE SL resource pool to include an NR synchronization time unit, or an NR SL resource pool to include an LTE synchronization time unit, causing unnecessary interference. Thus, it is necessary to consider the two types of RATS to determine the logical time unit to avoid the problems such as communication performance degradation caused by the possible conflicts between the two types of RATS in different application scenarios.

In the current application of an SL Technology, one type of radio access technology (RAT) is considered to determine a logical time unit, and the problem of determining the logical time unit when two types of RATs coexist on the same carrier has not been solved.

Thus, the present disclosure provides a sidelink communication method and apparatus, and provides a solution for end user equipment (UE) to determine a logical time unit by considering configuration information of two types of RATs when two types of RATs RATs coexist, so as to provide a basis for the UE to perform a communication service using the SL, thus preventing the communication interference that may be caused when the two RATs coexist.

The following is a detailed introduction to a sidelink communication method and apparatus provided by the present disclosure in combination with the accompanying drawings.

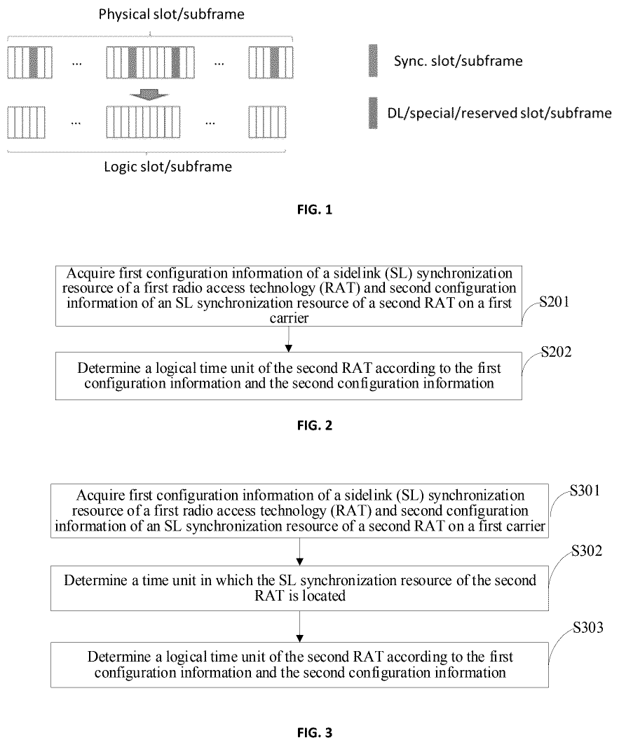

Before describing detailed embodiments of the present disclosure, a method for determining a logical time unit in a communication scenario using a sidelink communication technology is described. As shown in FIG. 1, FIG. 1 is a schematic diagram of a mode for determining a logical time unit in sidelink communication.

The logical time unit is a remaining time unit after removing a time unit used by the respective RAT to transmit SL synchronization signals and broadcast channels, a time unit with insufficient SL time-frequency resources, and a reserved time unit. In other words, for any RAT, in all physical time units, after removing the time unit for transmitting the SL synchronization signals and the broadcast channels, the time unit with insufficient SL time-frequency resources, and the reserved time unit, the remaining physical time unit is used as the logical time unit to be used to transmit communication information.

The time unit with the insufficient SL time-frequency resources may be, for example, a time unit for downlink transmission. For another example, in a time division duplexing (TDD) network, an OFDM symbol of a time slot may be divided into downlink, flexible or uplink, where the time unit with uplink time-frequency resources not enough to support the SL communications will also be removed.

When two types of RATs coexist on the same carrier at the same time, if each RAT removes the time unit of its own SL synchronization signal or broadcast channel, the determined logical time units of the two types of RATs will be different. For example, a synchronization time unit of an LTE SL may belong to a logical time unit of an NR SL, and vice versa. Since SL resource pools are defined on logical time units, it may cause an LTE SL resource pool to include an NR synchronization time unit, or an NR SL resource pool to include an LTE synchronization time unit, causing unnecessary interference.

In order to solve the above problems, the following describes a mode for UE to determine a logical time unit when two types of RATs coexist on the same carrier in combination with FIGS. 2 to 5.

FIG. 2 shows a schematic flowchart of a sidelink communication method. The method may be performed by end user equipment (UE). In the present disclosure, the UE includes but is not limited to an intelligent terminal device, a cellular phone, a wireless device, a handheld phone, a mobile unit, a vehicle, a vehicle-mounted device, etc.

In the embodiment of the present disclosure, the solution provided in the present disclosure can be used for a fifth generation mobile communication technology (5G) and subsequent communication technologies, such as a fifth generation-advanced mobile communication technology (5G-advanced) and a sixth generation mobile communication technology (6G), which is not limited in the present disclosure.

As shown in FIG. 2, the method may include the following steps.

S201, first configuration information of a sidelink (SL) synchronization resource of a first radio access technology (RAT) and second configuration information of an SL synchronization resource of a second RAT on a first carrier are acquired.

In the embodiment of the present disclosure, the configuration information may be configuration information of a resource pool of the UE. Specifically, the configuration information includes first configuration information of a first SL synchronization resource of the first RAT and second configuration information of a second SL synchronization resource of the second RAT on the first carrier.

In the embodiment of the present disclosure, the first RAT may be a long term evolution (LTE) technology, and the first SL synchronization resource of the first RAT may be an LTE SL synchronization resource. The second RAT may be a new radio (NR) technology, and the second SL synchronization resource of the second RAT may be an NR SL synchronization resource.

It may be understood that for LTE, a position of a synchronization time unit is required to be configured, and the first configuration information may include a position of an LTE SL synchronization time unit. For example, a time domain position of the LTE SL synchronization resource may be determined by the UE by (pre-)configuring or receiving configuration information acquired by downlink control information of a base station. For the NR, the second configuration information may include a time domain position of a synchronization time unit and the number of time units in each period. For example, when the UE supports both an LTE SL and an NR SL, the time domain position of the LTE SL synchronization resource may be acquired by the UE through an LTE RAT and inform an NR RAT of this information.

A key scenario discussed in the embodiment of the present disclosure is that the LTE SL and the NR SL coexist on the same carrier.

It should be understood that the resource pool of the UE may be configured by the UE based on the configuration information. The configuration for the resource pool described in the present disclosure refers to configuration for a second SL resource pool, that is, an NR SL resource pool. In addition, the present disclosure does not restrict whether the UE is receiving UE or transmitting UE. It should be understood that for sidelink communication between UEs, the configuration of the UE is aligned between the receiving UE and the transmitting UE.

In addition, the first configuration information or the second configuration information may be acquired by the UE from the pre-configuration of the UE, for example, the configuration information is acquired by reading pre-configuration data stored in a UE chip. Alternatively, in some embodiments of the present disclosure, the first configuration information or the second configuration information may be acquired by the UE by receiving downlink control information sent by a network device and acquiring configuration data from the downlink control information. The present disclosure does not restrict the mode for acquiring the configuration information by the UE.

In the application scenario of 5G, the network device mentioned above may be a 5G radio access network (NG-RAN) node, such as gNB or ng-eNB, where the gNB may be used for independent networking, while the ng-eNB may be used for backward compatibility with a 4G network to meet the application requirements of different core networks, and the specific use cases depend on the application scenario, which is not limited here.

S202, a logical time unit of the second RAT is determined according to the first configuration information and the second configuration information.

It may be understood that in the related art, the logical time unit is a remaining time unit after removing a time unit used by the respective RAT to transmit SL synchronization signals and broadcast channels, a time unit with insufficient SL time-frequency resources, and a reserved time unit. In other words, for any type of RAT, in all physical time units, after removing the time unit for transmitting the SL synchronization signals and the broadcast channels, the time unit with the insufficient SL time-frequency resources, and the reserved time unit, the remaining physical time unit is used as the logical time unit to be used to transmit communication information.

For example, a logical time unit of the LTE is a remaining time unit after removing a time unit used by the LTE to transmit SL synchronization signals and broadcast channels, a time unit with insufficient SL time-frequency resources, and a reserved time unit; and a logical time unit of an NR is a remaining time unit after removing a time unit used by the NR to transmit SL synchronization signals and broadcast channels, a time unit with insufficient SL time-frequency resources, and a reserved time unit. In other words, each RAT determines its own logical time unit of the RAT.

However, for the case that the UE supports the LTE SL and the NR SL at the same time, when two types of RATs coexist on the same carrier at the same time, if each RAT removes the time unit of its own SL synchronization signals or broadcast channels, the determined logical time units of the two types of RATs will be different. For example, a synchronization time unit of the LTE SL may belong to a logical time unit of the NR SL, and vice versa. Since the SL resource pools are defined on the logical time units, it may cause the LTE SL resource pool to include an NR synchronization time unit, or the NR SL resource pool to include an LTE synchronization time unit, causing unnecessary interference.

Thus, in the embodiment of the present disclosure, configurations of two types of RATs are considered to determine the logical time unit of the NR.

In other words, in the embodiment of the present disclosure, the logical time unit of the NR is determined by the UE based on the first configuration information of the LTE and the second configuration information of the NR, taking into account the configurations of two types of RATs compared to the related art.

It should be understood that the time unit described in the embodiment of the present disclosure may include a slot, a subframe, a frame, a subslot, an OFDM symbol, etc., which is not limited in the present disclosure.

In summary, according to the sidelink communication method provide by the present disclosure, the first configuration information of the SL synchronization resource of the first RAT and the second configuration information of the SL synchronization resource of the second RAT on the first carrier may be acquired by the UE; and the logical time unit of the second RAT is determined according to the first configuration information and the second configuration information. With regard to the coexistence situation in which two types of RATs operate over the same carrier frequency, the logical time unit is determined by the UE by simultaneously considering the configuration information of the two types of RATs when the two types of RATs coexist, so as to provide a basis for the UE to perform a communication service using the SL, thus preventing the communication interference that may be caused when the two types of RATs coexist.

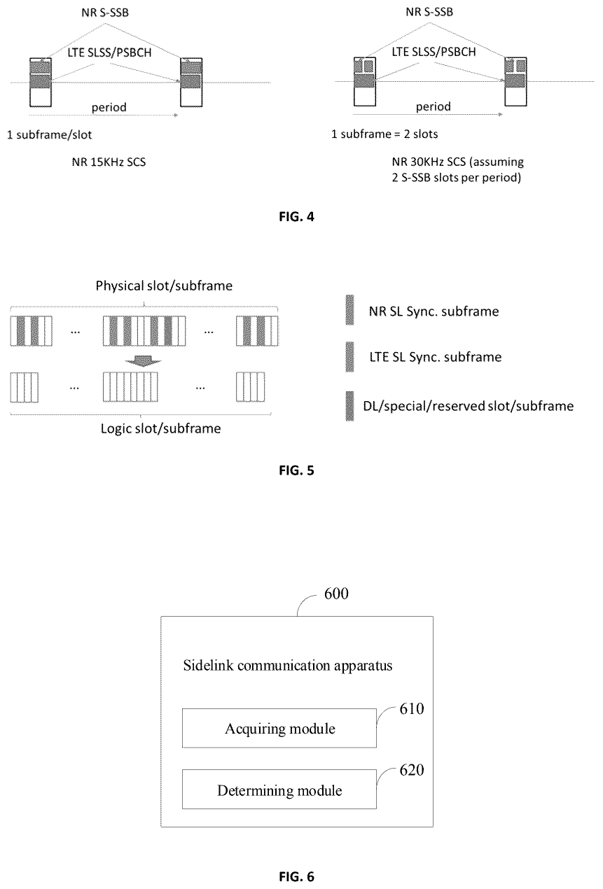

Based on the embodiment of FIG. 2, FIG. 3 shows a schematic flowchart of another sidelink communication method according to an embodiment of the present disclosure. The method may be performed by UE. As shown in FIG. 3, the method may include the following steps:

S301, first configuration information of a sidelink (SL) synchronization resource of a first radio access technology (RAT) and second configuration information of an SL synchronization resource of a second RAT on a first carrier are acquired.

In the embodiment of the present disclosure, the configuration information may be configuration information of a resource pool of the UE. Specifically, the configuration information includes first configuration information of a first SL synchronization resource of the first RAT and second configuration information of a second SL synchronization resource of the second RAT on the first carrier.

In the embodiment of the present disclosure, the first RAT may be a long term evolution (LTE) technology, and the first SL synchronization resource of the first RAT may be an LTE SL synchronization resource. The second RAT may be a new radio (NR) technology, and the second SL synchronization resource of the second RAT may be an NR SL synchronization resource.

A key scenario discussed in the embodiment of the present disclosure is that an LTE SL and an NR SL coexist on the same carrier.

In addition, the first configuration information or the second configuration information may be acquired by the UE from the pre-configuration of the UE, for example, the configuration information is acquired by reading pre-configuration data stored in a UE chip. Alternatively, in some embodiments of the present disclosure, the first configuration information or the second configuration information may be acquired by the UE by receiving downlink control information sent by a network device and acquiring configuration data from the downlink control information. The present disclosure does not restrict the mode for acquiring the configuration information by the UE.

The principle of step S301 in the embodiment is the same as the principle of step S201 in the above embodiment, and other corresponding explanations may refer to S201 and will not be repeated here.

S302, a time unit in which the SL synchronization resource of the second RAT is located is determined.

In the embodiment of the present disclosure, the problem solved by the present disclosure is that when the LTE SL and the NR SL coexist on the same carrier, two types of RATs are considered at the same time for the determination of logical time units, so as to avoid that unnecessary interference is caused by the case that a resource pool of the LTE SL includes an NR synchronization time unit or a resource pool of the NR SL includes an LTE synchronization time unit since each RAT determines the own logical time unit.

Since the SL resource pools are defined on the logical time units, the removal of the time unit in which the synchronization resource is located is required for the determination of the logical time unit. Thus, in the present embodiment, a method for determining a time unit in which the NR SL synchronization resource is located is emphatically introduced.

In an optional implementation of the present disclosure, determining the time unit in which the SL synchronization resource of the second RAT is located includes: a second time unit of the second RAT that coincides in a time domain with a first time unit in which the SL synchronization resource of the first RAT is located is determined as the time unit in which the SL synchronization resource of the second RAT is located.

In other words, the time unit in which the SL synchronization resource of the second RAT is located coincides in the time domain with the time unit in which the SL synchronization resource of the first RAT is located.

Specifically, it may be achieved through frequency-division multiplexing (FDM) of the NR SL synchronization resource and the LTE SL synchronization resource.

Based on the above description, as an example, as shown in FIG. 4, FIG. 4 shows an example of a method for determining a time unit of the NR SL synchronization resource. For example, when a sub-carrier space (SCS) of an NR SL is 15 KHz, a time length of a time unit (slot) of the NR SL is equal to a time length of a time unit (subframe) of an LTE SL. It is assumed that a subframe n in the LTE SL is configured as the time unit in which a resource for transmitting an LTE SL synchronization signal or broadcast channel is located. For the NR SL coexisting on the same carrier, a slot m that coincides in the time domain with the subframe n may be configured as the time unit in which the resource for transmitting an NR SL synchronization signal or broadcast channel is located. Since the period of a set of synchronization resources of the NR SL and the LTE SL is the same (160 ms), the set of synchronization resources of the two types of RATs may be completely configured on time-frequency resources that coincide in the time domain. Thus, when the logical time unit of an NR is determined, the time units of the synchronization resources for transmitting the synchronization signals or broadcast channels may be removed to avoid the situation where the two types of RATs have different logical time units.

For another example, when the SCS of the NR SL is 30 KHz, the time length of the time unit (slot) of the NR SL is twice that of the time unit (subframe) of the LTE SL, that is, the length of one LTE subframe is equal to the lengths of two NR slots. It is assumed that the subframe n in the LTE SL is configured as the time unit in which a resource for transmitting an LTE SL synchronization signal or broadcast channel is located. For the NR SL coexisting on the same carrier, two slots m that coincide in the time domain with the subframe n may be configured as the time unit in which the resource for transmitting the NR SL synchronization signal or broadcast channel is located. Synchronization resources of two types of RATs may be completely configured on time-frequency resources that coincide in the time domain, and one set of LTE synchronization resources and two sets of NR synchronization resources may be configured on time units that coincide in the time domain. Thus, when the logical time unit of the NR is determined, the time units of the synchronization resources for transmitting the synchronization signals or broadcast channels may be removed to avoid the situation where the two types of RATs have different logical time units.

A frequency domain position of the LTE SL synchronization resource in the subframe is not adjustable, and is located on six physical resource blocks (PRBs) centered on a center frequency position of the carrier, while a frequency domain position of the NR SL synchronization resource may be set by configuration (or pre-configuration). Thus, the frequency domain position of the NR SL synchronization resource may be configured on a position that does not coincide with a frequency domain of the LTE SL synchronization resource.

It should be understood that in the present embodiment, other types of time units (such as reserved time units or insufficient time units) that are required to be removed to determine the logical time unit are unchanged, may be identical to the related art and are not repeated here.

In another optional implementation of the present disclosure, determining the time unit in which the SL synchronization resource of the second RAT is located includes: according to the first configuration information, a first time unit reserved by the first RAT for no SL communication is determined; and a second time unit of the second RAT that coincides in a time domain with the first time unit is determined as the time unit in which the SL synchronization resource of the second RAT is located.

Specifically, as described in FIG. 1, in the process of determining the logical time unit, a synchronization time unit, a reserved time unit, and an insufficient time unit are required to be removed from physical time units to obtain the logical time unit. Thus, when the time unit of the NR for transmitting the synchronization resource is configured, the time unit of the NR for transmitting the synchronization resource may also be configured on a time slot that coincides in the time domain with a subframe reserved by the LTE that are not used for transmitting SL resources.

In other words, the time unit in which the synchronization resource of the second RAT is located coincides in the time domain with the time unit reserved by the second RAT for no SL communication.

The time unit reserved by the LTE for no SL communication may be related to the synchronization time unit in position, for example, being acquired through calculation by the formula according to the position of the synchronization time unit in the first configuration information of the LTE.

Thus, in the present embodiment, the NR synchronization resource is set on the subframe reserved by the LTE, so that the NR synchronization resource does not coincide with a logical subframe of the LTE in the time domain.

S303, a logical time unit of the second RAT is determined according to the first configuration information and the second configuration information.

Specifically, in an optional embodiment of the present disclosure, according to the first configuration information and second configuration information, the logical time unit of the second RAT is determined from the physical time units with the time unit in which the SL synchronization resource of the second RAT is located removed.

In the present embodiment, based on the time unit (synchronization time unit) in which the NR SL synchronization resource is located and that is determined in step S302, the synchronization time unit is removed from the physical time units, and in the remaining time units, an NR logical time unit is determined. The NR synchronization time unit may be a time unit (time slot) of the NR that coincides in the time domain with the time unit (subframe) in which the LTE SL synchronization resource is located, or a time unit (time slot) of the NR that coincides in the time domain with the time unit (subframe) reserved by the LTE for no SL communication as described in the above embodiments.

In short, in the physical time units with the NR synchronization time unit removed, other time units that should be removed as described in the embodiment shown in FIG. 1 are removed, and the remaining time units are determined as logical time units.

In another optional implementation of the present disclosure, determining the logical time unit of the second RAT according to the first configuration information and the second configuration information may further include: according to the first configuration information and the second configuration information, the logical time unit of the second RAT is determined from the physical time units with a target time unit removed, where, the target time unit includes the time unit in which the SL synchronization resource of the second RAT is located and the time unit in which the SL synchronization resource of the first RAT is located.

As shown in FIG. 5, FIG. 5 shows another solution for determining a logical time unit. When the NR logical time unit is determined, the time unit in which the LTE SL synchronization resource is located (LTE synchronization subframe) and the time unit in which the NR SL synchronization resource is located (NR synchronization time slot) may be removed, and in the remaining physical time units, for example, other time units that should be removed as described in the embodiment shown in FIG. 1 removed, and the remaining time units are determined as the logical time units.

In summary, according to the sidelink communication method provide by the present disclosure, the first configuration information of the SL synchronization resource of the first RAT and the second configuration information of the SL synchronization resource of the second RAT on the first carrier may be acquired by the UE, the synchronization time unit is determined first, and then the logical time unit of the second RAT is determined according to the first configuration information and the second configuration information. With regard to the coexistence situation in which two types of RATs operate over the same carrier frequency, the logical time unit is determined by the UE by simultaneously considering the configuration information of the two types of RATs when the two types of RATs coexist, so as to provide a basis for the UE to perform a communication service using the SL, thus preventing the communication interference that may be caused when the two types of RATs coexist. The present embodiment provides an optional mode for determining a synchronization time unit, a boundary of determining the logical time unit when two types of RATs coexist is extended, and communication interference possibly caused when two types of RATs coexist is avoided in a more flexible configuration mode.

It should be understood that the solution provided by the above embodiments of the present disclosure is intended to, when the NR SL and the LTE SL share the same carrier, remove the time slots that coincide in the time domain with the subframe in which the LTE SL synchronization resource is located when the logical time unit of the NR SL is determined. Thus, time synchronization between the NR SL resource pool configured on the NR SL logical time slot and the LTE SL synchronization signal can be avoided.

In addition, “Determining the logical time unit” in the embodiments described in FIGS. 1 to 5 above may specifically refer to determining an index of the logical time unit, and “removing the XXX time unit from the physical time units” described above may specifically refer to removing the index of the time unit, which will not be repeated in the present disclosure, and the specific implementation may refer to the relevant standards.

Thus, when the NR SL and the LTE SL coexist on the same carrier, in the embodiments of the present disclosure, by the ways of the FDM of the synchronization resources of two types of RATs, or removing the time slot that coincides in the time domain with the LTE SL synchronization resource when NR determines the NR SL logical time slot, and the like, the problem that the resource pool of the LTE SL includes the NR synchronization time unit or the resource pool of the NR SL includes the LTE synchronization time unit since the single RAT is separately considered to determine the logical time unit is solved, and unnecessary interference in the SL communication process is avoided.

In the above embodiments of the present disclosure, the methods provided in the embodiments of the present disclosure are introduced from the perspectives of the user equipment. In order to implement the functions in the methods provided by the above embodiments of the present disclosure, the user equipment may include a hardware structure and a software module, and the above functions are implemented in a form of the hardware structure, the software module, or the hardware structure plus the software module. A certain function of the above functions is executed in a form of the hardware structure, the software module or the hardware structure plus the software module.

The present disclosure further provides a sidelink communication apparatus corresponding to the sidelink communication methods provided by the above embodiments. Since the sidelink communication apparatus provided by the embodiment of the present disclosure corresponds to the sidelink communication methods provided by the above embodiments, the implementations of the sidelink communication method are also applicable to the sidelink communication apparatus provided by the present embodiment and are not described in detail in the present embodiment.

FIG. 6 is a schematic structural diagram of a sidelink communication apparatus 600 according to an embodiment of the present disclosure. The sidelink communication apparatus 600 may be configured for end user equipment (UE).

As shown in FIG. 6, the sidelink communication apparatus 600 may include an acquiring module 610 and a determining module 620. The acquiring module 610 is configured to acquire first configuration information of a sidelink (SL) synchronization resource of a first radio access technology (RAT) and second configuration information of an SL synchronization resource of a second RAT on a first carrier; and the determining module 620 is configured to determine a logical time unit of the second RAT according to the first configuration information and the second configuration information.

According to the sidelink communication apparatus provide by the present disclosure, the first configuration information of the SL synchronization resource of the first RAT and the second configuration information of the SL synchronization resource of the second RAT on the first carrier may be acquired by the UE; and the logical time unit of the second RAT is determined according to the first configuration information and the second configuration information. With regard to the coexistence situation in which two types of RATs operate over the same carrier frequency, the logical time unit is determined by the UE by simultaneously considering the configuration information of the two types of RATs when the two types of RATs coexist, so as to provide a basis for the UE to perform a communication service using the SL, thus preventing the communication interference that may be caused when the two types of RATs coexist.

In some embodiments of the present disclosure, the first RAT is a long term evolution (LTE) technology, and the second RAT is a new radio (NR) technology.

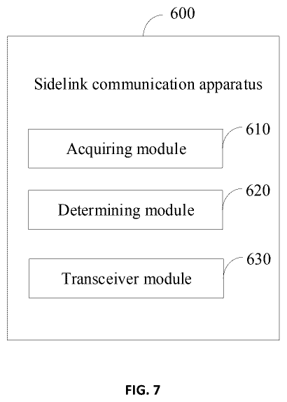

In some embodiments of the present disclosure, based on the embodiment shown in FIG. 6, as shown in FIG. 7, the sidelink communication apparatus 600 may further include a transceiver module 630, where the first configuration information and the second configuration information may be acquired by the acquiring module 610 by reading pre-configuration data of the UE; or the transceiver module 630 is configured to receive downlink control information transmitted by a network device, and the first configuration information and the second configuration information may be acquired by the acquiring module 610 based on the received downlink control information.

In some embodiments of the present disclosure, the determining module 620 is further configured to determine a time unit in which the SL synchronization resource of the second RAT is located.

In some embodiments of the present disclosure, the determining module 620 is further configured to determine a second time unit of the second RAT that coincides in a time domain with a first time unit in which the SL synchronization resource of the first RAT is located as the time unit in which the SL synchronization resource of the second RAT is located.

In some embodiments of the present disclosure, the determining module 620 is further configured to: determine a first time unit reserved by the first RAT for no SL communication according to the first configuration information, and determine a second time unit of the second RAT that coincides in a time domain with the first time unit as the time unit in which the SL synchronization resource of the second RAT is located.

In some embodiments of the present disclosure, the determining module 620 is further configured to: determine the logical time unit of the second RAT from physical time units with the time unit in which the SL synchronization resource of the second RAT is located removed according to the first configuration information and the second configuration information.

In some embodiments of the present disclosure, the determining module 620 is further configured to: determine the logical time unit of the second RAT from physical time units with a target time unit removed, where, the target time unit includes a time unit in which the SL synchronization resource of the second RAT is located and a time unit in which the SL synchronization resource of the first RAT is located according to the first configuration information and the second configuration information.

Thus, according to the sidelink communication apparatus provide by the present disclosure, the first configuration information of the SL synchronization resource of the first RAT and the second configuration information of the SL synchronization resource of the second RAT on the first carrier may be acquired by the UE, a synchronization time unit is determined first, and then the logical time unit of the second RAT is determined according to the first configuration information and the second configuration information. With regard to the coexistence situation in which two types of RATs operate over the same carrier frequency, the logical time unit is determined by the UE by simultaneously considering the configuration information of the two types of RATs when the two types of RATs coexist, so as to provide a basis for the UE to perform a communication service using the SL, thus preventing the communication interference that may be caused when the two types of RATs coexist. The present embodiment provides an optional mode for determining a synchronization time unit, the boundary of determining the logical time unit when two types of RATs coexist is extended, and communication interference possibly caused when two types of RATs coexist is avoided in a more flexible configuration mode.

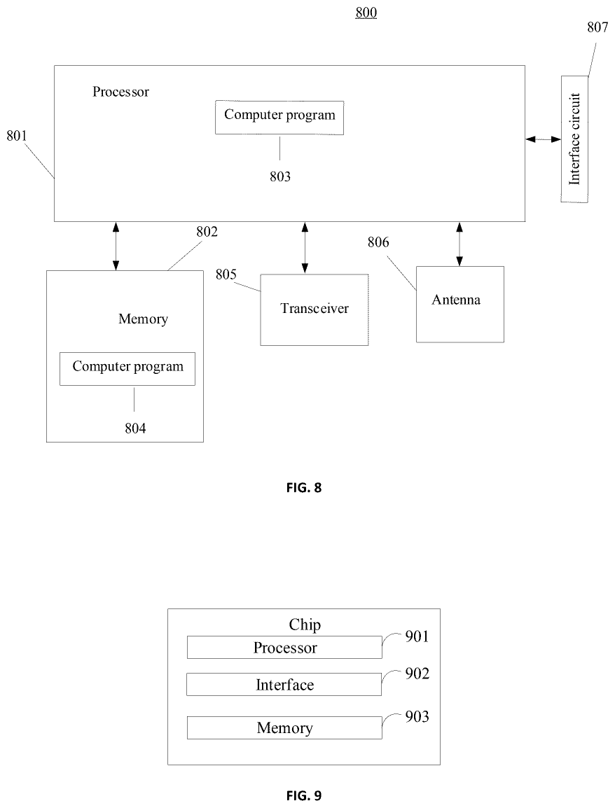

Referring to FIG. 8, FIG. 8 is a schematic structural diagram of a communication apparatus 800 according to an embodiment of the present disclosure. The communication apparatus 800 may be a network device, or user equipment, or a chip, a system on chip, or a processor, etc. that supports the network device to implement the above method, or a chip, a system on chip, or a processor, etc. that support the user equipment to achieve the above method. The apparatus may be configured to implement the methods described in the above method embodiments, and may refer to the description in the above method embodiments in details.

The communication apparatus 800 may include one or more processors 801. The processor 801 may be a general-purpose processor, or a specialized processor, etc. For example, the processor may be a baseband processor or a central processor. The baseband processor may be configured to process communication protocols and communication data, and the central processor may be configured to control the communication apparatus (such as base stations, baseband chips, terminal devices, terminal device chips, DUs or CUs, etc.), execute computer programs, and process data of the computer programs.

In some examples, the communication apparatus 800 may further include one or more memories 802 on which a computer program 804 may be stored, and the processor 801 executes the computer program 804 to cause the communication apparatus 800 to perform the methods described in the above method embodiments. In some examples, data may also be stored in the memory 802. The communication apparatus 800 and the memory 802 may be arranged separately or integrated together.

In some examples, the communication apparatus 800 may further include a transceiver 805 and an antenna 806. The transceiver 805 may be called a transceiver unit, a transmitter receiver, or a transceiver circuit, etc., to implement the transceiver function. The transceiver 805 may include a receiver and a transmitter, and the receiver may be called a receiving machine or a receiving circuit, etc., configured to implement the receiving function; and the transmitter may be called a transmitting machine or a transmitting circuit, etc., configured to implement the transmitting function.

In some examples, the communication apparatus 800 may further include one or more interface circuits 807. The interface circuit 807 is configured to receive code instructions and transmit the code instructions to the processor 801. The processor 801 runs code instructions to cause the communication apparatus 800 to perform the methods described in the above method embodiments.

In one implementation, the processor 801 may include a transceiver configured to implement the receiving and transmitting functions. For example, the transceiver may be a transceiver circuit, or an interface, or an interface circuit. The transceiver circuit, the interface, or the interface circuit configured to implement the receiving and transmitting functions may be separate or integrated together. The transceiver circuit, the interface or the interface circuit may be configured to read and write code or data, or the transceiver circuit, the interface or the interface circuit may be configured to transmit or transfer signals.

In one implementation, the processor 801 may store a computer program 803, and the computer program 803, when running on the processor 801, can cause the communication apparatus 800 to perform the methods described in the above method embodiments. The computer program 803 may be solidified in the processor 801, in which case the processor 801 may be implemented by hardware.

In one implementation, the communication apparatus 800 may include a circuit that may implement the function of transmitting or receiving or communicating in the above method embodiments. The processor and the transceiver described in the present disclosure may be implemented in an integrated circuit (IC), an analog IC, a radio frequency integrated circuit (RFIC), mixed-signal IC, an application specific integrated circuit (ASIC), a printed circuit board (PCB), an electronic device, etc. The processor and the transceiver may also be manufactured with various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus described in the above embodiment may be a network device or user equipment, but the scope of the communication apparatus described in the present disclosure is not limited to that, and the structure of the communication apparatus may not be limited by the figure. The communication apparatus may be an independent device or part of a larger device. For example, the communication apparatus may be:
(1) an independent integrated circuit (IC), or a chip, or a system on chip or a subsystem;
(2) a set having one or more ICs, in some examples, the IC set may also include a storage component for storing data and computer programs;
(3) an ASIC, such as a modem;
(4) a module that may be embedded in other devices;
(5) a receiver, a terminal device, an intelligent terminal device, a cellular phone, a wireless device, a handheld phone, a mobile unit, a vehicle device, a network device, a cloud device, an artificial intelligence device, etc.; or
(6) others.

For the case where the communication apparatus may be the chip or the system on chip, refer to the schematic structural diagram of a chip shown in FIG. 9. The chip shown in FIG. 9 includes a processor 901 and an interface 902. One or more processors 901 may be provided, and a plurality of interfaces 902 may be provided.

In some examples, the chip further includes a memory 903, configured to store necessary computer programs and data.

Those skilled in the art may also understand that various illustrative logical blocks and steps listed in the embodiments of the present disclosure may be implemented by electronic hardware, computer software, or a combination of both. Whether such functionality is implemented through hardware or software depends on a specific application and design requirements of an overall system. Those skilled in the art may implement the described functionality in varying ways for each particular application, but such implementations should not be interpreted as departing from the scope of protection of the embodiments of the present disclosure.

The present disclosure further provides a non-transitory computer-readable storage medium having an instruction stored, and the instruction, when executed by a computer, implements a function of any one of the method embodiments above.

The present disclosure further provides a computer program product, and the computer program product, when executed by a computer, implements a function of any one of the method embodiments above.

In the above embodiments, the function may be implemented in whole or in part by software, hardware, firmware, or any combination of them. When implemented using software, it may be implemented in whole or in part in a form of the computer program product. The computer program product includes one or more computer programs. When the computer program is loaded and executed on the computer, a process or function in accordance with the embodiments of the present disclosure is produced in whole or in part. The computer may be a general-purpose computer, a specialized computer, a computer network, or other programmable apparatuses. The computer program may be stored in a computer-readable storage medium or transmitted from one computer-readable storage medium to another computer-readable storage medium. For example, the computer program may be transmitted from a web site, a computer, a server, or a data center to another website site, computer, server, or data center in a wired (e.g., a coaxial cable, an optical fiber, and a digital subscriber line (DSL)) or wireless (e.g., infrared, wireless, and microwave) mode. The computer-readable storage medium may be any usable medium that is accessible by a computer or a data storage device such as a server and a data center that includes one or more usable media integrated. The usable medium may be a magnetic medium (e.g., a floppy disk, a hard disk, and a magnetic tape), an optical medium (e.g., a high-density digital video disc (DVD)), or a semiconductor medium (e.g., a solid state disk (SSD)), and the like.

It may be understood by those of ordinary skill in the art that various numerical symbols of first, second, etc. referred to in the present disclosure are for the purpose of convenient description, are not used to limit the scope of the embodiments of the present disclosure, and also represent the sequence.

At least one in the present disclosure may also be described as one or more, which may be two, three, four or more, which is not limited by the present disclosure. In the embodiments of the present disclosure, for a technical feature, technical features of this technical feature are distinguished by “first”, “second”, “third”, “A”, “B”, “C”, “D”, etc., and the technical features described by the “first”, “second”, “third”, “A”, “B”, “C” and “D” have no order of precedence or magnitude.

As used here, terms “machine-readable media” and “computer-readable media” refer to any computer program product, device, and/or apparatus (e.g., a disk, an optical disc, a memory, and a programmable logic device (PLD)) configured to provide machine instructions and/or data to a programmable processor, including, a machine-readable medium that receives machine instructions as machine-readable signals. The term “machine-readable signals” refers to any signal used to provide machine instructions and/or data to a programmable processor.

Systems and techniques described here may be implemented in a computing system (e.g., as a data server) including background components, or a computing system(e.g., an application server) including middleware components, or a computing system (e.g., a user computer with a graphical user interface or a web browser through which a user may interact with the implementations of the systems and technologies described here) including front-end components, or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally far away from each other and usually interact via a communication network. The relationship between the client and the server is generated by computer programs running on the corresponding computer and having a client-server relationship with each other.

It should be understood that various forms of processes shown above may be used to reorder, add, or delete steps. For example, the steps recorded in the present disclosure may be performed in parallel, sequentially or in different orders as long as desired results of the technical solution disclosed by the present disclosure can be implemented, which is not limited here.

In addition, it should be understood that various embodiments of the present disclosure may be implemented individually or in combination with other embodiments as permitted by the solution.

Those of ordinary skill in the art will appreciate that elements and algorithm steps of examples described in combination with the embodiments disclosed here may be implemented by electronic hardware, or a combination of computer software and electronic hardware. Whether to implement such functionality with hardware or software depends upon a particular application of the technical solutions and constraint conditions of design. A skilled person may implement the described functionality in varying ways for each particular application, but such implementation should not be interpreted as departing from the scope of the present disclosure.

A person skilled in the art may clearly understand that for the convenience and simplicity of description, specific working processes of the system, apparatus and unit described above may refer to corresponding processes in the above-mentioned method embodiments, which will not be repeated here.

The above is the specific implementation of the present disclosure, however, the scope of protection of the present disclosure is not limited to this, and changes or substitutions which may be easily conceived by those skilled in the art within the technical scope disclosed in the present disclosure should fall within the scope of protection of the present application. Accordingly, the scope of protection of the present disclosure shall be as set forth in the scope of protection of claims.

1. A sidelink communication method, performed by user equipment (UE), the sidelink communication method comprising:
acquiring first configuration information of a sidelink (SL) synchronization resource of a first radio access technology (RAT) and second configuration information of an SL synchronization resource of a second RAT on a first carrier; and
determining a logical time unit of the second RAT according to the first configuration information and the second configuration information.

2. The sidelink communication method according to claim 1, wherein the first RAT is a long term evolution (LTE) technology, and the second RAT is a new radio (NR) technology.

3. The sidelink communication method according to claim 1, wherein acquiring first configuration information of the sidelink (SL) synchronization resource of the first radio access technology (RAT) and the second configuration information of the SL synchronization resource of the second RAT on the first carrier comprises:
reading pre-configuration data of the UE to obtain the first configuration information and the second configuration information; or
receiving downlink control information transmitted by a network device to acquire the first configuration information and the second configuration information.

4. The sidelink communication method according to claim 1, further comprising:
determining a time unit in which the SL synchronization resource of the second RAT is located.

5. The sidelink communication method according to claim 4, wherein determining the time unit in which the SL synchronization resource of the second RAT is located comprises:
determining a second time unit of the second RAT that coincides in a time domain with a first time unit in which the SL synchronization resource of the first RAT is located as the time unit in which the SL synchronization resource of the second RAT is located.

6. The sidelink communication method according to claim 4, wherein determining the time unit in which the SL synchronization resource of the second RAT is located comprises:
determining a first time unit reserved by the first RAT for no SL communication according to the first configuration information; and
determining a second time unit of the second RAT that coincides in a time domain with the first time unit as a time unit in which the SL synchronization resource of the second RAT is located.

7. The sidelink communication method according to claim 4, wherein determining the logical time unit of the second RAT according to the first configuration information and the second configuration information comprises:
determining a logical time unit of the second RAT from physical time units with the time unit in which the SL synchronization resource of the second RAT is located removed according to the first configuration information and the second configuration information.

8. The sidelink communication method according to claim 4, wherein determining the logical time unit of the second RAT according to the first configuration information and the second configuration information comprises:
determining a logical time unit of the second RAT from physical time units with a target time unit removed according to the first configuration information and the second configuration information, where, the target time unit comprises a time unit in which the SL synchronization resource of the second RAT is located and a time unit in which the SL synchronization resource of the first RAT is located.

9. (canceled)

10. A communication apparatus, comprising a transceiver, a memory, and one or more processors which are connected to the transceiver and the memory,
wherein the one or more processors are collectively configured to execute a computer program stored in the memory to cause the communication apparatus to:
control transceiving of radio signals of the transceiver;
acquire first configuration information of a sidelink (SL) synchronization resource of a first radio access technology (RAT) and second configuration information of an SL synchronization resource of a second RAT on a first carrier; and
determine a logical time unit of the second RAT according to the first configuration information and the second configuration information.

11. A non-transitory computer-readable storage medium, storing computer-executable instructions, wherein one or more processors are collectively configured to execute the computer-executable instructions to:
acquire first configuration information of a sidelink (SL) synchronization resource of a first radio access technology (RAT) and second configuration information of an SL synchronization resource of a second RAT on a first carrier; and
determine a logical time unit of the second RAT according to the first configuration information and the second configuration information.

12. The communication apparatus according to claim 10, wherein, the one or more processors are collectively configured to execute a computer program stored in the memory to cause the communication apparatus to:
read pre-configuration data of user equipment (UE) to obtain the first configuration information and the second configuration information; or
receive downlink control information transmitted by a network device to acquire the first configuration information and the second configuration information.

13. The communication apparatus according to claim 10, wherein, the one or more processors are collectively configured to execute a computer program stored in the memory to cause the communication apparatus to:
determine a time unit in which the SL synchronization resource of the second RAT is located.

14. The communication apparatus according to claim 13, wherein, the one or more processors are collectively configured to execute the computer program stored in the memory to cause the communication apparatus to:
determine a second time unit of the second RAT that coincides in a time domain with a first time unit in which the SL synchronization resource of the first RAT is located as the time unit in which the SL synchronization resource of the second RAT is located.

15. The communication apparatus according to claim 13, wherein, the one or more processors are collectively configured to execute the computer program stored in the memory, so as to cause the communication apparatus to:
determine a first time unit reserved by the first RAT for no SL communication according to the first configuration information; and
determine a second time unit of the second RAT that coincides in a time domain with the first time unit as a time unit in which the SL synchronization resource of the second RAT is located.

16. The communication apparatus according to claim 13, wherein, the one or more processors are collectively configured to execute the computer program stored in the memory to cause the communication apparatus to:
determine a logical time unit of the second RAT from physical time units with the time unit in which the SL synchronization resource of the second RAT is located removed according to the first configuration information and the second configuration information.

17. The communication apparatus according to claim 10, wherein, the one or more processors are collectively configured to execute the computer program stored in the memory to cause the communication apparatus to:
determine a logical time unit of the second RAT from physical time units with a target time unit removed according to the first configuration information and the second configuration information, where the target time unit comprises a time unit in which the SL synchronization resource of the second RAT is located and a time unit in which the SL synchronization resource of the first RAT is located.

18. The non-transitory computer-readable storage medium according to claim 11, wherein the one or more processors are collectively configured to execute the computer-executable instructions to:
read pre-configuration data of user equipment (UE) to obtain the first configuration information and the second configuration information; or
receive downlink control information transmitted by a network device to acquire the first configuration information and the second configuration information.

19. The non-transitory computer-readable storage medium according to claim 11, wherein the one or more processors are collectively configured to execute the computer-executable instructions, to:
determine a time unit in which the SL synchronization resource of the second RAT is located.

20. The non-transitory computer-readable storage medium according to claim 19, wherein the one or more processors are collectively configured to execute the computer-executable instructions to:
determine a second time unit of the second RAT that coincides in a time domain with a first time unit in which the SL synchronization resource of the first RAT is located as the time unit in which the SL synchronization resource of the second RAT is located; or
determine a first time unit reserved by the first RAT for no SL communication according to the first configuration information, and determine a second time unit of the second RAT that coincides in a time domain with the first time unit as a time unit in which the SL synchronization resource of the second RAT is located.

21. The non-transitory computer-readable storage medium according to claim 19, wherein the one or more processors are collectively configured to execute the computer-executable instructions to:
determine a logical time unit of the second RAT from physical time units with the time unit in which the SL synchronization resource of the second RAT is located removed according to the first configuration information and the second configuration information; or
determine a logical time unit of the second RAT from physical time units with a target time unit removed according to the first configuration information and the second configuration information, where the target time unit comprises a time unit in which the SL synchronization resource of the second RAT is located and a time unit in which the SL synchronization resource of the first RAT is located.
